(19) United States
(12) Patent Application Publication
(10) Pub. No.: US 2007/0149023 A1
(43) Pub. Date: Jun. 28, 2007

(54) Electrical connector assembly with cover

(75) Inventors: Fu-Pin Hsieh, Tu-Cheng (TW); Fang-Jwu Liao, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/645,431

(22) Filed: Dec. 26, 2006

(30) Foreign Application Priority Data
Dec. 26, 2005 (CN) 200510134925.6

(51) Int. Cl. H01R 29/00

(52) U.S. Cl. 439/188

(57) ABSTRACT

An electrical connector assembly (10) includes an insulating housing (11), a plurality of contacts (12) received in the housing, a cover (13) attached to the housing, a pair of metal position posts (14, 15) with different size for positioning the housing and the cover. A groove (111) is formed on the housing along the direction of the diagonal of the housing, which is divided the housing into two regions. The groove is configured to relieve the stress imparted on the housing such that the housing are not bow when heated.

### BACKGROUND OF THE INVENTION

1. FIELD OF THE INVENTION

The present invention relates to the art of electrical connectors, and more particularly to an electrical connector provided for mechanically and electrically connecting a chip module to a printed circuit board (PCB).

2. DESCRIPTION OF THE RELATED ART

One conventional electrical connector provided for mechanically and electrically connecting a chip module to a print circuit board (PCB) is shown in FIG. 1. The electrical connector 1 includes an insulating housing 2, a cover 4, a plurality of contacts 3 received in the housing 2. Some taper bumps 21 are formed opposite each other on the outside of the housing 2. The cover 3 defines a number of latches 41 corresponding to the taper bumps 21. During assembly, the cover 4 attaches to the housing 2 via a pair of metal position posts (5, 6) with different size which is formed in the direction of the diagonal of the housing 2, at the same time, the latches 41 engages with the taper bumps 21. The outer of the plane 8 defines a plurality of groove 7 in order to prevent the housing 2 from bowing when heated. Nevertheless, if the housing 2 is too big, said means for preventing the housing 2 from bowing when heated are not come true. Therefore, there is a need to provide a new electrical connector assembly for preventing the housing from bowing when heated.

### SUMMARY OF THE INVENTION

An electrical connector assembly according to an embodiment of the present invention includes an insulating housing, a plurality of contacts received in the housing, a cover attached to the housing, a pair of metal position posts with different size for positioning the housing and the cover. A groove is formed on the housing along the direction of the diagonal of the housing, which is divided the housing into two regions. As compared with the prior art, the groove is configured to relieve the stress imparted on the housing such that the housing are not bow when heated.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an exploded, perspective view of a conventional electrical connector assembly;

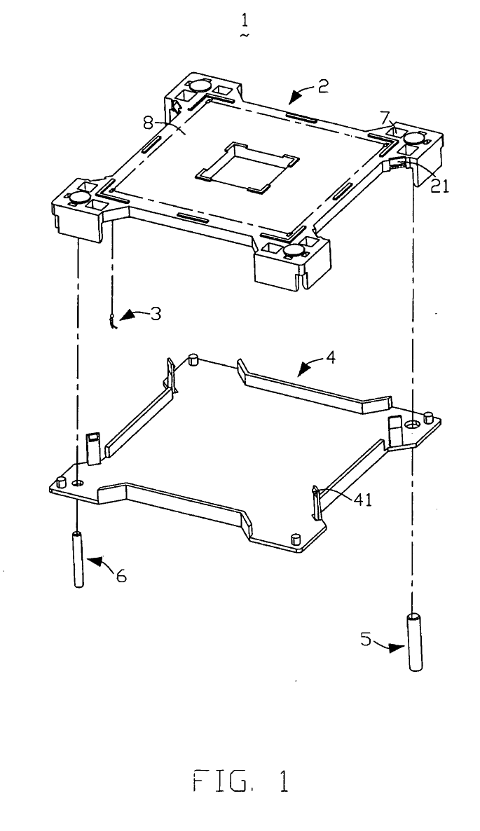

FIG. 2 is an exploded, perspective view of an electrical connector assembly according to an embodiment of the present invention;

FIG. 3 is an enlarged view of a circled portion III of FIG. 2;

FIG. 4 is a planform view of the housing and position posts of FIG. 2; and

FIG. 5 is an assembled view of FIG. 2.

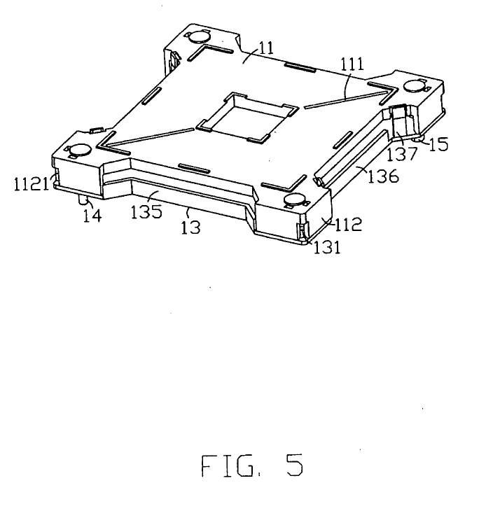

### DETAILED DESCRIPTION OF PREFERRED EMBODIMENT

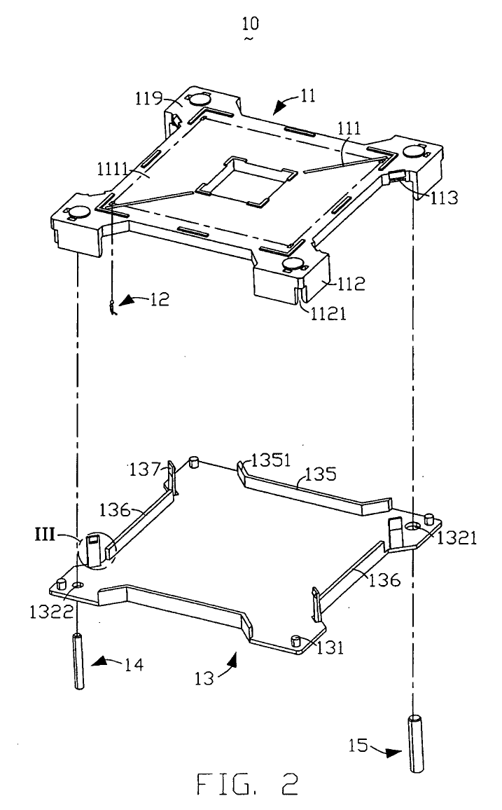

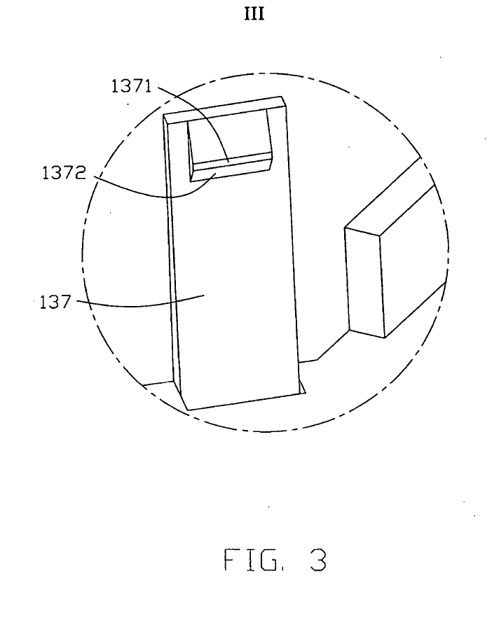

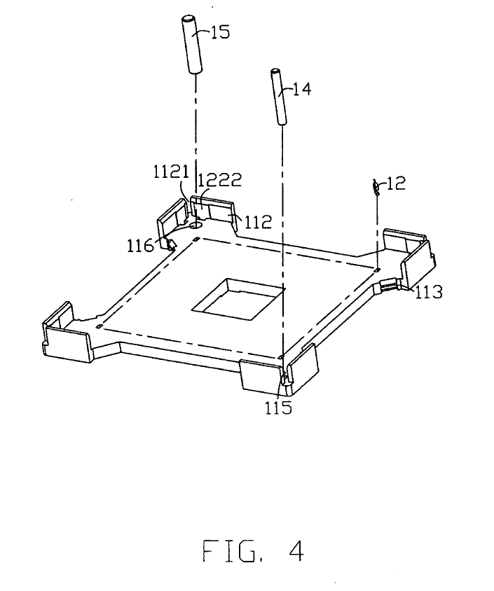

Referring to FIGS. 2 to 4, an electrical connector assembly 10 according to the embodiment of the present invention comprises an insulating housing 11, a plurality of contacts 12 received in the housing 11, a cover 13 attached to the housing 11, a pair of metal position posts (14,15) with different size for positioning the housing 11 and the cover 13. A groove 111 is formed on the housing 11 along the direction of the diagonal of the housing 11, which is divided the housing 11 into two regions.

The housing 11 has a generally rectangular body 1111 with four arrowlike cornrs 119. Four L-shaped sidewalls 112 extend laterally from the four corners 119, and a central gap 1121 notched each sidewall 112. The inner sidewall 112 has two positioning members 1222 formed opposite each other on both sides of the central gap 1121. The positioning members 1222 locate and position the chip with respect to the housing 11 such that the chip pads align and engage housing contacts 12 to facilitate electrical communication between the chip and the housing 11. The housing 11 includes a pair of locating holes (115, 116) with different sizes for receiving the corresponding metal posts (14, 15). A bump 113 is formed on each lateral side of each arrowlike corner 119 for clipping the corresponding spring-latch 137 of the cover 13.

The cover 13 is preferably formed as a plastic part and is sized and configured to accommodate the housing 11. The cover 13 includes a set of alignment posts 131 for assisting position the cover 13 with respect to the housing 11. The cover 13 has a spring-latch 137 formed on each lateral side of each corner, which is corresponding to the bump 113. Each spring-latch 137 is stepped in shaped to form an upper taper bump 1371 for clipping the corresponding bump 113 of the housing 11 and an inclined plane 1372. Two vertical chock blocks 136 extend laterally from the base of the cover 13 between the adjacent latches 137. The cover 13 also includes two blocks 135 with wings 1351 formed on the other two sides of the base.

In assembly, the metal position posts (14, 15) are pre-inserted into the locating holes (115, 116). The cover 13 then attached on the housing 11. The alignment posts 131 are cooperative with corresponding sidewalls 112 to accurately maintain the cover 13 assembly in position so that the metal position posts (14, 15) are inserted into the through-holes (1321, 1322) in the cover 13. At the same time, the cover 13 is pressed down until the spring-latch 137 engages with the corresponding bumps 113.

In this embodiment, the grooves may be through out the housing, and besides, in an alternative embodiment, the groove formed on the housing are employed in place of a plurality of slots arrayed in the housing.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. An electrical connector assembly comprising:
an insulating housing having a body and four corners, said body defining a top surface and a bottom surface;
at least one groove defined diagonally along one of the top surface and the bottom surface of the housing, dividing the housing into two regions;
a number of passageways disposed in the two regions; and
a plurality of contacts received in said passageways.

2. The electrical connector assembly as recited in claim 1, further comprising a cover attaching on the housing and a pair of metal position posts with different size for positioning the housing and the cover when assembly.

3. The electrical connector assembly as recited in claim 2, wherein said metal position posts are generally cylinder.

4. The electrical connector assembly as recited in claim 1, wherein said groove is employed in place of a plurality of slots arrayed in the housing.

5. The electrical connector assembly as recited in claim 1, wherein said groove is through-hole.

6. The electrical connector assembly as recited in claim 1, wherein said groove is dead hole.

7. The electrical connector assembly as recited in claim 1, wherein said groove is formed on top surface of the body.

8. The electrical connector assembly as recited in claim 1, wherein said groove is formed on bottom surface of the body.

9. The electrical connector assembly as recited in claim 1, wherein a pair of posts are located at two opposite corners of said four corners.

10. An electrical connector assembly comprising:
an insulating housing defining a top surface and a bottom surface;
a pair of fastening devices located on two opposite side regions of the housing
at least one elongated recess defined along one of the top surface and the bottom surface of the housing, dividing the housing into two regions corresponding to the pair of fastening devices;
a number of passageways disposed in two regions; and
a plurality of contacts received in said passageways.

11. The electrical connector assembly as claimed in claim 10, wherein there are two said elongated recesses formed on the top surface and the bottom surface, respectively.

12. The electrical connector assembly as claimed in claim 10, wherein said at least one elongated recess is located between the pair of fastening devices.

13. The electrical connector assembly as claimed in claim 12, wherein said pair of fastening devices are aligned with said elongated recess along an elongated direction defined by said elongated recess.

14. The electrical connector as claimed in claim 10, wherein the pair of fastening devices are located at two opposite corners of the housing.

15. The electrical connector as claimed in claim 14, wherein the elongated recess extends along a diagonal direction of the housing.

16. An electrical connector assembly comprising:
an insulating housing defining a top surface and a bottom surface;
a pair of fastening devices located on two opposite side regions of the housing
at least one elongated structure defined along one of the top surface and the bottom surface of the housing, dividing the housing into two regions corresponding to the pair of fastening devices;
a number of passageways disposed in two regions; and
a plurality of contacts received in said passageways.

17. The electrical connector assembly as claimed in claim 16, wherein said at least one elongated recess is located between the pair of fastening devices.

18. The electrical connector assembly as claimed in claim 17, wherein said pair of fastening devices are aligned with said elongated recess along an elongated direction defined by said elongated recess.

19. The electrical connector as claimed in claim 16, wherein the pair of fastening devices are located at two opposite corners of the housing.

20. The electrical connector as claimed in claim 19, wherein the elongated recess extends along a diagonal direction of the housing.
